(19) United States
(12) Patent Application Publication
(10) Pub. No.: US 2024/0198901 A1
(43) Pub. Date: Jun. 20, 2024

(54) SOUND OUTPUT DEVICE FOR VEHICLE

(71) Applicant: TOYODA GOSEI CO., LTD., Kiyosu-shi (JP)

(72) Inventors: Masashi OTOYO, Kiyosu-shi (JP); Kazuhisa TAKAHASHI, Kiyosu-shi (JP); Koji OKUMURA, Kiyosu-shi (JP); Takumi ISHII, Kiyosu-shi (JP); Yoshiharu TANAKA, Kiyosu-shi (JP)

(21) Appl. No.: 18/521,030

(22) Filed: Nov. 28, 2023

(30) Foreign Application Priority Data
Dec. 15, 2022 (JP) 2022-200362

(51) Int. Cl. B60Q 5/00; G10K 15/04

(52) U.S. Cl. CPC B60Q 5/00; G10K 15/04; B60Q 5/008

(57) ABSTRACT

A sound output device for a vehicle includes an exterior component forming a part of an outer shell of the vehicle, a vibration generator disposed inward of the exterior component in an outward-inward direction of the vehicle, and an interposed portion disposed between the exterior component and the vibration generator and having an attachment portion to which the vibration generator is attached. The sound output device for the vehicle is configured to transmit vibration of the vibration generator to the exterior component via the interposed portion to cause sound waves to be emitted from the exterior component. The interposed portion includes a plate-shaped joining portion between the exterior component and the attachment portion, the joining portion protruding inward in the outward-inward direction from the exterior component. The exterior component and the interposed portion are integrally formed of a plastic.

### BACKGROUND

### 1. Field

The present disclosure relates to a sound output device for a vehicle, which is mounted on the vehicle and emits sound waves to notify a person near the vehicle of the presence of the vehicle by the sound waves.

### 2. Description of Related Art

Various sound output devices for vehicles have been developed that emit sound waves to notify a person near the vehicle of the presence of the vehicle by the sound waves (see, for example, Japanese Laid-Open Patent Publication No. 2012-153305).

Some sound output devices include an exterior component, a vibration generator, and an interposed portion. The exterior component forms a part of the outer shell of the vehicle. The vibration generator is disposed inward of the exterior component in an outward-inward direction of the vehicle. The interposed portion is disposed between the exterior component and the vibration generator. The intermediate portion includes an attachment portion at the inner side in the outward-inward direction. The interposed portion is attached to the vibration generator at the attachment portion. Also, the interposed portion is connected to the exterior component at a portion further outward than the attachment portion in the outward-inward direction.

In the above-described sound output device, when the vibration generator vibrates, the vibration is transmitted to the exterior component via the interposed portion. Sound waves generated by the vibration of the exterior component are emitted to the outside of the vehicle in the outward-inward direction. When the sound waves reach a person near the vehicle, the person is notified of the presence of the vehicle.

In the above-described sound output device, if the exterior component and the interposed portion are integrally formed of plastic, there is the following concern. Due to the difference in the amount of volume shrinkage when the molten plastic is cooled, recesses (dents) called “sink marks” form on the outer surface in the outward-inward direction of the portion of the exterior component to which the interposed portion is connected. Such sink marks impair the appearance of the exterior component. Therefore, the above-described sound output device of the related art has room for improvement in terms of the appearance of the exterior component.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a sound output device for a vehicle includes an exterior component forming a part of an outer shell of the vehicle, a vibration generator disposed inward of the exterior component in an outward-inward direction of the vehicle, and an interposed portion disposed between the exterior component and the vibration generator and having an attachment portion to which the vibration generator is attached. The sound output device is configured to transmit vibration of the vibration generator to the exterior component via the interposed portion to cause sound waves to be emitted from the exterior component. The interposed portion includes a plate-shaped joining portion between the exterior component and the attachment portion, the joining portion protruding inward in the outward-inward direction from the exterior component. The exterior component and the interposed portion are integrally formed of a plastic.

In another general aspect, a sound output device for a vehicle includes an exterior component forming a part of an outer shell of the vehicle, a vibration generator disposed inward of the exterior component in an outward-inward direction of the vehicle, and an interposed portion disposed between the exterior component and the vibration generator and having an attachment portion to which the vibration generator is attached. The sound output device is configured to transmit vibration of the vibration generator to the exterior component via the interposed portion to cause sound waves to be emitted from the exterior component. The exterior component is formed of a plastic. The interposed portion is formed by a member different from the exterior component. The interposed portion is formed of a plastic in a state of being in close contact with an inner surface of the exterior component in the outward-inward direction.

Other features and aspects will be apparent from the following detailed description, the drawings, and the claims.

### BRIEF DESCRIPTION OF THE DRAWINGS

FIG. 1 is a partial perspective view of a sound output device for a vehicle according to a first embodiment.

FIG. 2 is a partial rear view of the sound output device shown in FIG. 1.

FIG. 3 is a vertical cross-sectional view taken along line 3-3 in FIG. 1, illustrating the sound output device.

FIG. 4 is a partial perspective view corresponding to FIG. 1, illustrating a sound output device for a vehicle according to a second embodiment.

FIG. 5 is a partial vertical cross-sectional view corresponding to FIG. 3, illustrating the sound output device according to the second embodiment.

FIG. 6 is a vertical cross-sectional view of a sound output device for a vehicle according to a modification.

FIG. 7 is a vertical cross-sectional view of a front end portion of a vehicle in which the sound output device according to the modification is incorporated.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, except for operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

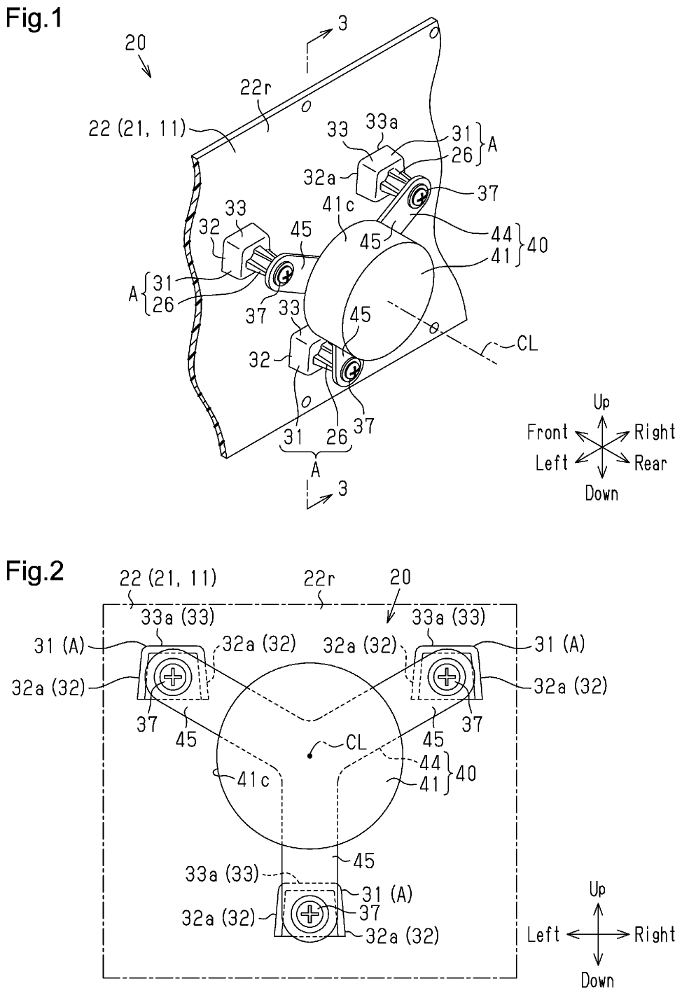

A sound output device 20 for a vehicle 10 according to a first embodiment will now be described with reference to FIGS. 1 to 3.

In the following description, the direction in which the vehicle 10 advances forward will be referred to as the front, and the reverse direction will be referred to as the rear. The vertical direction refers to the vertical direction of the vehicle 10, and the left-right direction refers to the vehicle width direction that agrees with the left-right direction when the vehicle 10 is advancing forward.

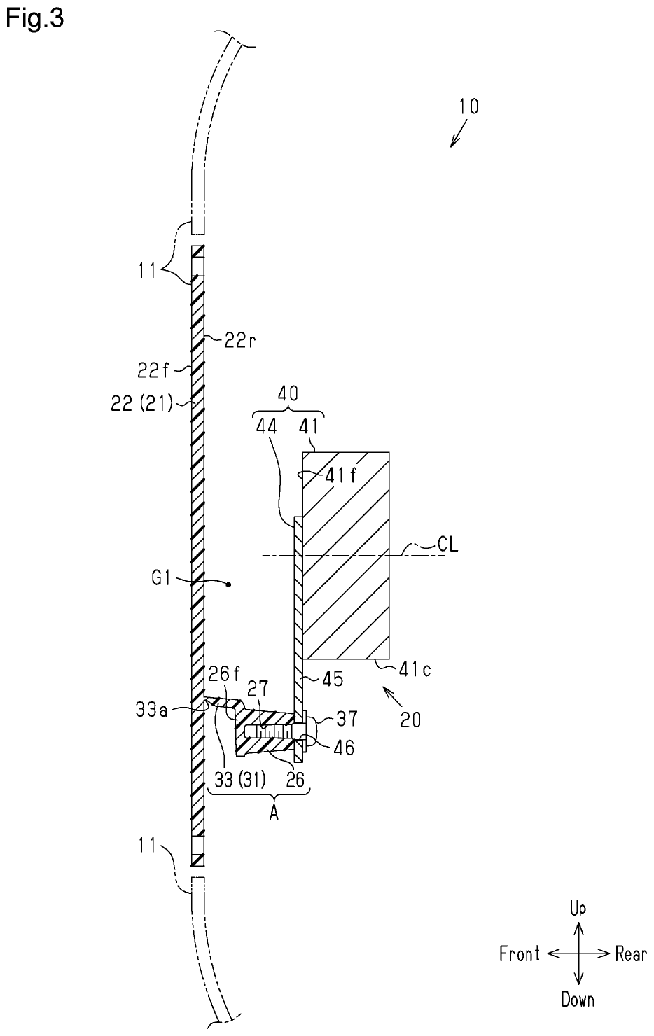

As shown in FIG. 3, the vehicle 10 of the first embodiment is, for example, a battery electric vehicle, a hybrid electric vehicle, a fuel cell electric vehicle, or the like, which is capable of traveling by an electric motor that generates rotational power when energized. Also, the vehicle 10 has quiet traveling noise.

A front panel 11 forming a part of an outer shell of the vehicle 10 is disposed at a front end portion of the vehicle 10.

The sound output device 20 is mounted on the front end portion of the vehicle 10. The sound output device 20 emits sound waves forward of the vehicle 10 to notify a person in front of the vehicle 10 of the presence of the vehicle 10 with the sound waves. In the first embodiment, the front-rear direction of the sound output device 20 corresponds to an outward-inward direction of the vehicle 10. The “forward direction” of each part of the sound output device 20 corresponds to the “outward direction” of the vehicle 10, and the “rearward direction” of each part corresponds to the “inward direction” of the vehicle 10.

As shown in FIGS. 1 to 3, the sound output device 20 includes an exterior component 21, a vibration generator 40, and interposed portions A. The components constituting the sound output device 20 will now be described.

### Exterior Component 21

The exterior component 21 forms a part or the entirety of the front panel 11. In the first embodiment, the exterior component 21 forms a part of the front panel 11. The exterior component 21 does not have an opening.

The exterior component 21 includes a plate-shaped portion 22 that intersects, in this case, is orthogonal to, a central axis CL of the vibration generator 40, which will be discussed below. The plate-shaped portion 22 may obliquely intersect with the central axis CL. A front surface 22f (see FIG. 3) of the plate-shaped portion 22 forms a part of a decorative surface of the front panel 11. The exterior component 21 is fixed to a structure (not shown) provided in the vehicle 10, such as a frame, an exterior panel, or a cover, by a method such as screw fastening.

### Vibration Generator 40

The vibration generator 40 is disposed at a position spaced rearward from the plate-shaped portion 22 by a predetermined distance with a gap G1 (see FIG. 3). The vibration generator 40 includes a columnar main body 41 and a support portion 44, which is disposed at a position forward of and adjacent to the main body 41. The main body 41 has the central axis CL extending in the front-rear direction at a central portion thereof. An outer circumferential surface 41c of the main body 41 is formed by a cylindrical surface centered on the central axis CL. A front surface 41f (see FIG. 3) of the main body 41 is formed by a plane intersecting with the central axis line CL. The front surface 41f is orthogonal to the central axis line CL in the present embodiment.

The support portion 44 is formed to be plate from a hard material such as a hard metal or plastic, and has a high rigidity. The support portion 44 includes multiple (three in the first embodiment) arms 45 each extending radially outward from the central axis CL. The arms 45 are disposed at equal angular intervals around the central axis CL. The support portion 44 is fixed to the main body 41 by a method such as screw fastening or bonding. An outer portion of each arm 45 in the radial direction protrudes outward from the outer circumferential surface 41c. A screw insertion hole 46 (see FIG. 3) extending in the front-rear direction is formed in a portion of each arm 45 protruding from the outer circumferential surface 41c.

The vibration generator 40, which has the above-described configuration, vibrates the exterior component 21 in the front-rear direction to generate sound waves having frequencies in an audible range as horn sound for warning, an approach notification sound for notifying that the vehicle 10 has approached, or the like. The horn sound is emitted from the plate-shaped portion 22 at a predetermined single frequency. The approach notification sound is emitted from the plate-shaped portion 22 as a melody, music, or the like.

A controller (not shown) is mounted on the vehicle 10. For example, the controller outputs an operation instruction signal to the main body 41 to vibrate the main body 41 in response to the traveling state of the vehicle 10, detection of a pedestrian by a sensor (not shown), or the like.

### Interposed Portion A

The interposed portions A are disposed in the gap G1 (see FIG. 3) between the plate-shaped portion 22 and the vibration generator 40. In the first embodiment, the interposed portions A are disposed at multiple locations around the central axis CL. The interposed portions A are disposed only in parts of the gap G1.

Each interposed portion A includes an attachment portion 26, which forms a rear portion, and a coupling portion 31, which forms a front portion.

The attachment portion 26 of each interposed portion A extends in the front-rear direction along the central axis CL and has a columnar shape. Each attachment portion 26 is located forward of the screw insertion hole 46 in the corresponding arm 45. Each attachment portion 26 has a thread hole 27 that is open in the rear end surface and extends forward (see FIG. 3).

The coupling portion 31 of each interposed portion A is located between the plate-shaped portion 22 and the attachment portion 26. Each coupling portion 31 protrudes rearward from a rear surface 22r of the plate-shaped portion 22 and has the shape of a plate.

Each coupling portion 31 has two plate-shaped vertical coupling portions 32 and one plate-shaped lateral coupling portion 33. The two vertical coupling portions 32 extend in the up-down direction and the front-rear direction while being spaced apart from each other in the left-right direction. The single lateral coupling portion 33 is spanned between upper ends of the two vertical coupling portions 32. The lateral coupling portion 33 extends in the left-right direction and the front-rear direction.

Front ends of the vertical coupling portions 32 and the lateral coupling portion 33 are connected to the rear surface 22r of the plate-shaped portion 22. A connecting portion 32a (see FIG. 2) of each vertical coupling portion 32 connected to the rear surface 22r is formed to be thinner than other parts of the vertical coupling portion 32. A connecting portion 33a of the lateral coupling portion 33 connected to the rear surface 22r is formed to be thinner than other parts of the lateral coupling portion 33 (see FIG. 3).

The rear end of the coupling portion 31 of each interposed portion A is connected to the attachment portion 26. Specifically, the rear end of the region surrounded by the two vertical coupling portions 32 and the lateral coupling portion 33 is located forward of a front end 26f of the attachment portion 26 of each interposed portion A. Each coupling portion 31 is connected to the front end 26f at the rear ends of the two vertical coupling portions 32 and the rear end of the lateral coupling portion 33. The rear end of the region of each coupling portion 31 is closed by the front end 26f. The region of each coupling portion 31 is open at the lower end.

The exterior component 21 and the interposed portions A are integrally formed of a hard plastic.

Further, the vibration generator 40 is attached to each of the attachment portions 26 by screws 37 inserted through the screw insertion holes 46 and screwed into the thread holes 27. In this manner, the vibration generator 40 is attached to the plate-shaped portion 22 from the rear side with the interposed portions A at multiple positions.

Operation of the first embodiment, which is configured as described above, will now be described.

In the first embodiment, in which the interposed portions A are molded with plastic together with the exterior component 21, a large difference between the thickness of the plate-shaped portion 22 and the thickness of the portion of each interposed portion A connected to the plate-shaped portion 22 may cause the following concerns when they are integrally formed. Due to the difference in the amount of volume shrinkage when molten plastic is cooled, recesses (dents) called “sink marks” form on the front surface 22f of the portion of the plate-shaped portion 22 to which the interposed portion A is connected. Such sink marks impair the appearance of the exterior component 21.

In this regard, in the first embodiment, each interposed portion A has the coupling portion 31 between the plate-shaped portion 22 and the attachment portion 26. The coupling portion 31 of each interposed portion A protrudes rearward from the plate-shaped portion 22 and forms a part of the interposed portion A connected to the plate-shaped portion 22. The coupling portion 31 of each interposed portion A has the shape of a plate and is connected at its front end to the rear surface 22r of the plate-shaped portion 22. Therefore, as compared with a case in which each interposed portion A does not have the plate-shaped coupling portion 31 and the attachment portion 26 is directly connected to the rear surface 22r of the plate-shaped portion 22, the difference between the thicknesses of the plate-shaped portion 22 and the portion (coupling portion 31) of each interposed portion A connected to the plate-shaped portion 22 is small, and sink marks are less likely to form.

When the vibration generator 40 is attached to the exterior component 21, the vibration generator 40 is disposed such that the screw insertion hole 46 in each arm 45 is located behind the thread hole 27 of the corresponding interposed portion A, as shown in FIG. 3. The screws 37 are inserted into the screw insertion holes 46 from the rear side. By screwing the screws 37 into the thread holes 27, the vibration generator 40 is fastened to the attachment portion 26. By fastening all the attachment portions 26 with the screws 37, the vibration generator 40 is attached to the exterior component 21 with the multiple interposed portions A.

In this state, when the exterior component 21 is viewed from the front side of the vehicle 10, the front surface 22f with no or few sink marks is visible. The exterior component 21, which has no opening, covers the interposed portions A and the vibration generator 40 from the front side. Therefore, the interposed portions A and the vibration generator 40 are either not visible or difficult to see from the front side of the vehicle 10.

In the above-described state, when the controller (not shown) outputs an operation instruction signal to the main body 41, the main body 41 is vibrated in response to the operation instruction signal. Then, the vibration is transmitted to the interposed portions A through the attachment portions 26 via the support portion 44, and is further transmitted to the exterior component 21. When the exterior component 21 is vibrated, sound waves are generated, and the sound waves are emitted forward from the exterior component 21. When the sound wave reaches a person near the vehicle 10, particularly a person in front of the vehicle 10, the person is notified of the presence of the vehicle 10 from behind.

In the first embodiment, as described above, the vibration of the main body 41 is transmitted to the exterior component 21 via the support portion 44 and the interposed portions A, so that sound waves are generated. Therefore, the loss of energy of the vibration caused when the vibration is transmitted from the main body 41 to the exterior component 21 is small as compared with a case in which the vibration generator 40 is not attached to the plate-shaped portion 22 with the interposed portions A and the vibration of the main body 41 is transmitted to the exterior component 21 only with the gap G1.

Particularly, in the first embodiment, when the main body 41 vibrates, the vibration is transmitted to the exterior component 21 via the interposed portions A disposed at multiple locations around the central axis CL. The vibration of the main body 41 is transmitted to multiple parts of the exterior component 21. This efficiently transmits the vibration to the exterior component 21. Accordingly, the loss of energy until the sound waves are emitted from the exterior component 21 is further reduced.

In the first embodiment, the part of the vibration generator 40 different from the parts attached to the attachment portions 26 is spaced rearward from the plate-shaped portion 22 with the gap G1 and is not pressed by the plate-shaped portion 22. Therefore, the main body 41 is more likely to vibrate than in a case in which the main body 41 is pressed.

For example, if the main body 41 is directly attached to the exterior component 21, which includes the plate-shaped portion 22 and does not have an opening as described above, without using the interposed portions A or the support portion 44, there exist the following concerns. If the front surface 41f of the main body 41 does not have a shape corresponding to the shape of the rear surface 22r of the plate-shaped portion 22, for example, if the rear surface 22r is formed by a curved surface and the front surface 41f is formed by a flat surface, a gap is formed between the front surface 41f and the rear surface 22r. The gap reduces the transmission efficiency of vibration. If the gap is filled with, for example, a hard cushion material in order to efficiently transmit the vibration of the main body 41 to the exterior component 21, there exist the following concerns. Specifically, when adhesive members such as double-sided adhesive tapes are used to fix the cushion material to the plate-shaped portion 22 and the main body 41, the number of components of the sound output device 20 increases, accordingly.

In this regard, in the first embodiment, the vibration of the main body 41 is transmitted to the plate-shaped portion 22 via the support portion 44 and the interposed portions A. Therefore, it is not necessary to fill the gap between the plate-shaped portion 22 and the main body 41 with a cushion material. Accordingly, it is not necessary to use adhesive members.

In addition, when the gap is filled with a cushion material and adhesive members, the durability of the cushion material and the adhesive members may decrease due to heat, vibration, or the like, and the performance of transmitting vibration may decrease. In this regard, each interposed portion A is formed of a hard plastic in the first embodiment. The support portion 44 is formed of a hard material. Therefore, the support portion 44 and the interposed portions A are less likely to be affected by heat, vibration, or the like than the cushion material and the adhesive members.

The first embodiment has the following advantages.

(1-1) In the first embodiment, the exterior component 21 and the interposed portions A are integrally formed of a plastic as shown in FIG. 3. That is, in the first embodiment, the exterior component 21 and the interposed portions A, which are integrated, are of a one-piece design. Therefore, when the exterior component 21 is molded with plastic, the interposed portions A can be molded together. In addition, since the exterior component 21 and the interposed portion A are integrated with each other, the number of components of the sound output device 20 is reduced as compared with a case in which the exterior component 21 and the interposed portions A are formed separately.

(1-2) In the first embodiment, each plate-shaped coupling portion 31 is placed between the attachment portion 26 of each interposed portion A and the plate-shaped portion 22 as shown in FIG. 3, so that each interposed portion A is connected to the plate-shaped portion 22 at the coupling portion 31. Therefore, when the exterior component 21 and the interposed portions A are molded with plastic, the formation of sink marks on the front surface 22f of the plate-shaped portion 22 is suppressed. This prevents the appearance of the exterior component 21 from being degraded due to the formation of sink marks.

In addition, the durability of the interposed portions A is higher than in a case in which the main body 41 is attached to the exterior component 21 using a cushion material and adhesive members. This prevents the vibration transmission performance from being reduced due to a decrease in the durability.

(1-3) In the first embodiment, the vibration generator 40 is attached to the exterior component 21 with the interposed portions A as shown in FIG. 3. This allows the vibration of the vibration generator 40 to be transmitted to the exterior component 21 via the interposed portions A. The exterior component 21 is vibrated to generate sound waves, and the sound waves are emitted forward from the exterior component 21. This structure reduces the loss of energy when the vibration generator 40 is vibrated until the sound waves are emitted from the exterior component 21. Accordingly, the vehicle 10 is capable of generating and emitting sound waves of regulated intensity and volume as defined by law, effectively notifying a person near the vehicle 10, especially a person in front of the vehicle 10, of the presence of the vehicle 10. The person in this embodiment is typically a pedestrian, but also includes a person riding an automobile, a person riding a bicycle, and the like.

(1-4) With the configuration described in (1-3) above, the vibration of the main body 41 can be transmitted to the exterior component 21 via the support portion 44 and the interposed portions A without filling the gap between the plate-shaped portion 22 and the main body 41 with a hard cushion material. Accordingly, it is not necessary to use adhesive members. This reduces the number of components used to attach the main body 41 to the exterior component 21 and thus reduces the costs.

(1-5) In the first embodiment, the interposed portions A, which include the attachment portions 26, are disposed only in parts of the gap G1 between the plate-shaped portion 22 and the vibration generator 40, as shown in FIG. 3. With such an arrangement, the part of the vibration generator 40 different from the parts attached to the attachment portions 26 is spaced rearward from the plate-shaped portion 22 with the gap G1. Therefore, as compared with a case in which the front surface 41f of the main body 41 is pressed against the rear surface 22r of the plate-shaped portion 22, the main body 41 vibrates more easily, increasing the propagation efficiency of the sound waves.

(1-6) In the first embodiment, the attachment portions 26 are disposed at multiple locations around the central axis CL as shown in FIG. 1. This allows the vibration of the vibration generator 40 to be transmitted to the exterior component 21 via the attachment portions 26 at multiple locations. This increases the vibration transmission efficiency.

(1-7) In the first embodiment, the vibration generator 40 is fastened to the attachment portion 26 by a simple operation of inserting the screws 37 through the screw insertion holes 46 of the arms 45 and screwing the screws 37 into the thread holes 27 of the attachment portions 26, as shown in FIG. 3. This configuration allows the vibration generator 40 to be attached to the exterior component 21 from the rear side with the interposed portions A. This simplifies the structure for attaching the vibration generator 40 to the attachment portions 26.

(1-8) In the first embodiment, the exterior component 21 does not have an opening as shown in FIGS. 1 to 3. Therefore, the interposed portions A and the vibration generator 40 are either not visible or difficult to see from the front side of the vehicle 10. This improves the appearance of the front portion of the vehicle 10.

### Second Embodiment

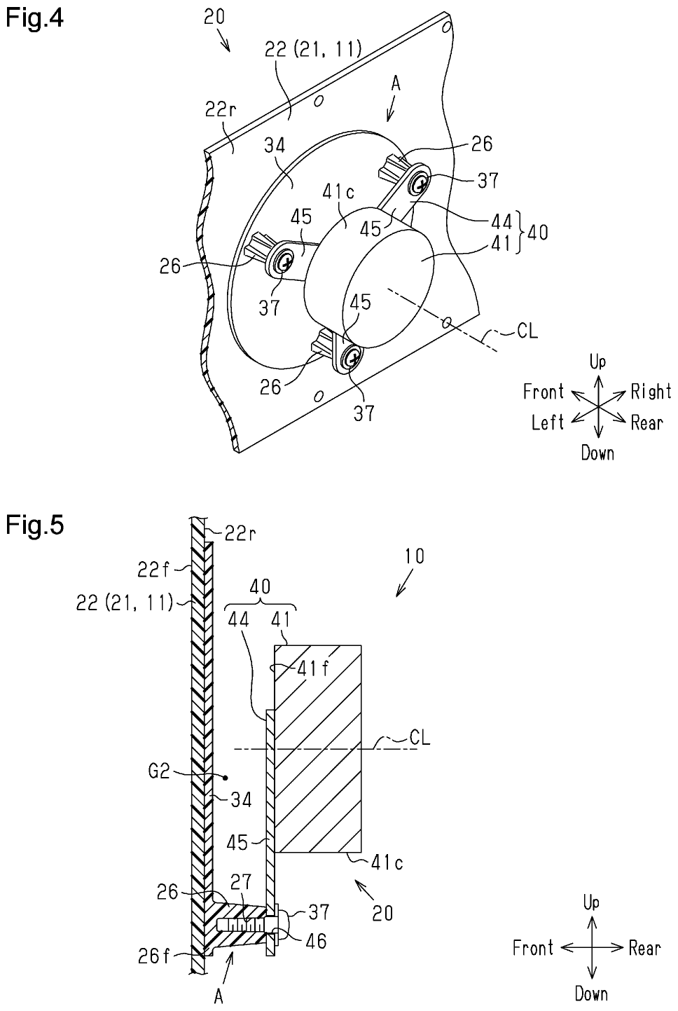

Next, a sound output device for a vehicle according to a second embodiment will be described with reference to FIGS. 4 and 5.

The second embodiment is the same as the first embodiment in that the exterior component 21 is made of a plastic.

The second embodiment is different from the first embodiment in that an interposed portion A is a member separate from the exterior component 21. Further, in the second embodiment, the coupling portions 31 in the first embodiment are omitted, and a flat plate portion 34 is added. The flat plate portion 34 and multiple attachment portions 26 form a single interposed portion A. The multiple attachment portions 26 are disposed only in parts of a gap G2 between the flat plate portion 34 and the vibration generator 40. The gap G2 is located between the exterior component 21 and the vibration generator 40.

The front ends 26f of the attachment portions 26 are made of plastic and in close contact with the rear surface 22r of the plate-shaped portion 22, which is molded with plastic. Specifically, the circular flat plate portion 34, the center of which is the central axis CL is stacked on the rear surface 22r (see FIG. 4). The flat plate portion 34 is formed to have a diameter larger than that of an imaginary circle (not shown) that is centered on the central axis CL and passes through all the attachment portions 26. The front end 26f of each attachment portion 26 forms a part of the flat plate portion 34. In other words, all the attachment portions 26 are coupled to each other by the flat plate portion 34. The flat plate portion 34 forms a part of the interposed portion A in the second embodiment. Similarly to the front ends 26f, the part of the flat plate portion 34 different from the front ends 26f is made of plastic and in close contact with the rear surface 22r of the plate-shaped portion 22.

The part of the vibration generator 40 different from the parts attached to the attachment portions 26 is spaced rearward from the flat plate portion 34 with the gap G2.

The exterior component 21 and the interposed portion A are formed in a state of being joined together by a two-color molding process.

The configuration, other than the above, is the same as the first embodiment. Thus, in the second embodiment, the same components as those in the first embodiment are given the same reference numerals, and detailed explanations are omitted.

As described above, the second embodiment has the same configuration as that of the first embodiment except that the interposed portion A includes the flat plate portion 34 instead of the coupling portions 31, and the exterior component 21 and the interposed portion A are formed by a two-color molding process. Thus, the second embodiment thus achieves substantially the same operations as the first embodiment.

Next, aspects of the operation of the second embodiment that are different the first embodiment will be described.

If the exterior component 21 and an interposed portion A that does not include the flat plate portion 34 and includes the attachment portions 26 are integrally formed of a plastic, there exist the following concerns. Depending on the difference in thicknesses between the plate-shaped portion 22 and the attachment portions 26, the difference in the amount of volume shrinkage when molten plastic is cooled can form sink marks in parts of the front surface 22f of the plate-shaped portion 22 to which the attachment portions 26 are connected.

In this regard, in the second embodiment, the exterior component 21, which is made of plastic, and the interposed portion A, which is a plastic member different from the exterior component 21, are molded with plastic by a two-color molding process. In the two color molding process, a portion corresponding to the first shot, for example, the exterior component 21 is molded before the interposed portion A. Thereafter, a portion corresponding to the second shot in the same mold, in this case, the interposed portion A is molded in a state of being in contact with the rear surface 22r of the plate-shaped portion 22.

Therefore, when cooled, the plate-shaped portion 22 is unlikely to be affected by the volume shrinkage of the interposed portion A being cooled. Even if the plate-shaped portion 22 is affected by the volume shrinkage, the influence is less than that in a case in which the exterior component 21 and the interposed portion A that does not include the flat plate portion 34 and includes the attachment portions 26 are formed integrally and simultaneously. Therefore, sink marks are less likely to form in the part of the front surface 22f of the plate-shaped portion 22 to which the interposed portion A is connected.

The second embodiment thus achieves the same advantages as the advantages (1-3), (1-4), and (1-6) to (1-8) of the first embodiment. In addition, the second embodiment achieves the following advantages in place of the advantages (1-2) and (1-5).

(2-1) In the second embodiment, the exterior component 21 and the interposed portion A are formed in succession by a two-color molding process, with the exterior component 21 formed first, followed by the interposed portion A, with a time delay between the formations. Therefore, as compared with a case in which the exterior component 21 and the attachment portion 26 are molded simultaneously, sink marks are less likely to form in the front surface 22f of the plate-shaped portion 22. This prevents the appearance of the exterior component 21 from being degraded due to the formation of sink marks.

In addition, similar to the above advantage (1-2), the durability of the interposed portion A is higher than in a case in which the main body 41 is attached to the exterior component 21 using a cushion material and adhesive members. This prevents the vibration transmission performance from being reduced due to a decrease in the durability.

(2-2) In the second embodiment, a part of the interposed portion A is formed by the flat plate portion 34. The exterior component 21 and the interposed portion A are formed by a two-color molding process in a state in which the flat plate portion 34 including the front end 26f of each attachment portion 26 is brought into close contact with the plate-shaped portion 22. Therefore, the interposed portion A can be formed in a state in which the wide surface of the flat plate portion 34 is in contact with the plate-shaped portion 22. The interposed portion A is firmly bonded to the exterior component 21.

(2-3) In the second embodiment, the attachment portions 26 are disposed only in parts of the gap G2 between the flat plate portion 34 and the vibration generator 40, as shown in FIG. 5. With such an arrangement, the part of the vibration generator 40 different from the parts attached to the attachment portions 26 is spaced rearward from the flat plate portion 34 with the gap G2. Therefore, similarly to the above-described advantage (1-5), as compared with a case in which the front surface 41f of the main body 41 is pressed against the rear surface 22r of the plate-shaped portion 22, the main body 41 vibrates more easily, increasing the propagation efficiency of the sound waves.

The above-described embodiments may be modified as follows. The above-described embodiments and the following modifications can be combined if the combined modifications remain technically consistent with each other.

### Modifications of Exterior Component 21

The exterior component 21 in the first and second embodiments may have an opening. In this case, there is no particular restriction on the number, size and shape of the openings.

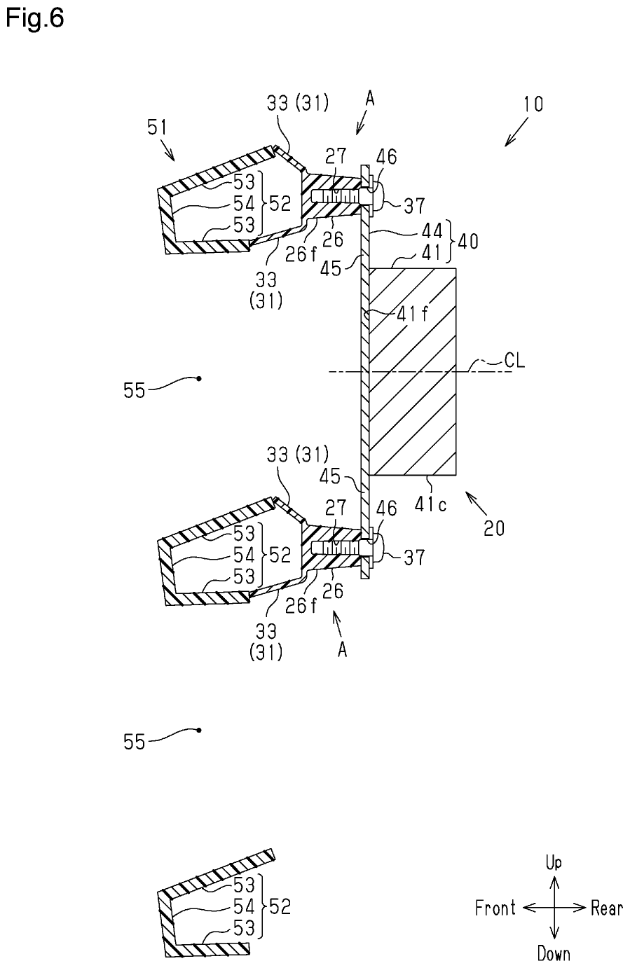

For example, a part or all of a front grille (also referred to as a radiator grill) shown in FIG. 6, which is disposed forward of a radiator (not shown), may be formed by an exterior component 51.

The front grille includes a loop-shaped frame (not shown) and a lattice disposed in a region surrounded by the frame. The lattice includes multiple lateral bars 52 extending in the front-rear direction and the left-right direction while being spaced apart from each other in the up-down direction. Each lateral bar 52 includes two lateral plates 53 extending in the left-right direction while being spaced apart from each other in the up-down direction, and a front plate 54 extending in the up-down direction and the left-right direction and connecting the front ends of the lateral plates 53. The rear end of each lateral bar 52 is open.

The gap between the lateral bars 52 adjacent to each other in the up-down direction forms a part of an opening 55 that guides outside air to the radiator, the engine, and the like in the engine compartment as the vehicle 10 travels.

A part or all of the front grille having the above-described configuration may be formed by the exterior component 51. In this case, if the main body 41 is attached to the exterior component 51 by using a cushion material and adhesive members as described in the first and second embodiments, there exist the following concerns.

Unlike the exterior component 21 in the first and second embodiments, the exterior component 51 has a small number of planar portions like the plate-shaped portion 22 in the exterior component 21. Since the rear end of each lateral bar 52 is open, the rear end face of each lateral plate 53 corresponds to the above-described planar portion. Although a cushion material is attached to the rear end face with an adhesive member, the area of the rear end face is small. Accordingly, a region in which the cushion material and the adhesive member can be arranged is small. Therefore, it is difficult to dispose the cushion material and the adhesive member between the lateral bar 52 and the main body 41. In addition, it is difficult to attach the main body 41 to the lateral bars 52 with the cushion material and the adhesive member.

Therefore, as shown in FIG. 6, the interposed portions A having the configuration described in the first embodiment may be used, and the vibration generator 40 may be attached to some of the lateral bars 52. In this modification, each interposed portion A includes an attachment portion 26, which has thread holes 27, and plate-shaped lateral coupling portions 33 (coupling portions 31), which are disposed between the lateral plates 53 and the attachment portion 26 and connect the lateral plates 53 to the attachment portion 26. The lateral coupling portions 33 (coupling portions 31) in each interposed portion A are fixed to, for example, the rear end faces of the lateral plates 53 by a method such as bonding or vibration welding. The vibration generator 40 is fastened to the respective attachment portions 26 by screwing the screws 37 inserted into the screw insertion holes 46 of the arms 45 into the thread holes 27 of the attachment portions 26.

In this modification as well, the vibration of the vibration generator 40 is transmitted to the exterior component 51 via the interposed portions A as in the first embodiment. The exterior component 51 vibrates to generate sound waves, and emits some of the sound waves forward. The sound waves notify, from behind, a person in front of the vehicle 10 of the presence of the vehicle 10.

Accordingly, this modification achieves the same advantages as the above-described advantages (1-3), (1-4), (1-6), and (1-7).

In addition, since the exterior component 51 and the interposed portions A are not molded integrally with plastic, the formation of sink marks is suppressed.

The interposed portions A may have the configuration described in the second embodiment.

In the modification of FIG. 6, the exterior component 51 and the interposed portions A may be integrally formed of plastic as in the first embodiment.

Further, in the modification of FIG. 6, similarly to the second embodiment, the lateral bar 52 and the interposed portion A may be formed by a two-color molding process. In this case, each interposed portion A may be formed in a state in which each lateral coupling portion 33 is in close contact with the rear end faces of the lateral plates 53 of each lateral bar 52.

Any of the above modifications suppresses the formation of sink marks and improves the appearance of the exterior component 51.

In the first and second embodiments, the plate-shaped portion 22 may be omitted from the exterior component 21.

### Modification of Interposed Portion A

The number of the interposed portions A in the first embodiment may be changed to one. In addition, the number of the attachment portions 26 in the second embodiment may be changed to one.

In any case, the attachment portion 26 may be disposed on the central axis CL, or may be disposed at a position radially separated from the central axis CL, for example.

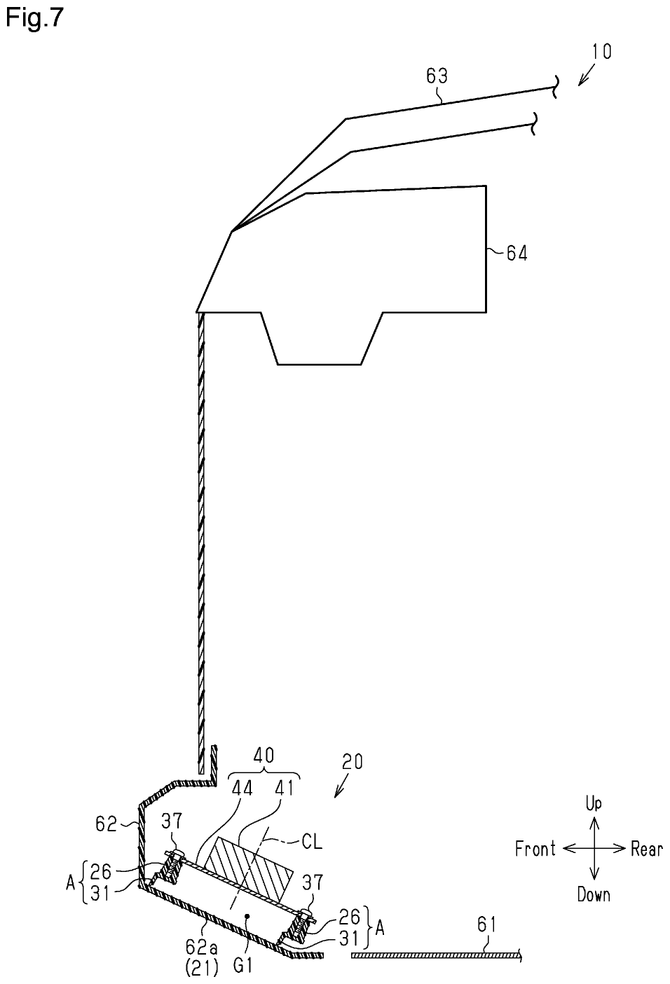

In the first embodiment, the interposed portions A may be disposed at two locations or more than three locations around the central axis CL. When the interposed portions A are disposed at two locations, as shown in FIGS. 6 and 7, the interposed portions A may be disposed at positions opposed to each other across the central axis CL.

In addition, in the second embodiment, the attachment portions 26 may be disposed at two locations or more than three locations around the central axis CL. When the attachment portions 26 are disposed at two locations, the attachment portions 26 may be disposed at positions opposed to each other across the central axis CL.

In the first embodiment, the interposed portions A do not necessarily need to be arranged at equal angular intervals around the central axis CL. Also, in the second embodiment, the attachment portions 26 do not necessarily need to be arranged at equal angular intervals around the central axis CL.

The exterior component 21 and the respective interposed portions A in the first embodiment may be formed separately. In this case, the front end of the coupling portion 31 in each interposed portion A may be fixed to the rear surface 22r of the plate-shaped portion 22 by a method such as vibration welding or bonding.

In addition, in the second embodiment, in which the exterior component 21 and the interposed portion A are formed separately, the flat plate portion 34 in the interposed portion A may be fixed to the rear surface 22r of the plate-shaped portion 22 by a method such as vibration welding or bonding.

In any of the above-described modifications, since the exterior component 21 and the interposed portion A are not formed integrally, the formation of sink marks is suppressed.

The shape of the coupling portions 31 may be changed to a shape different from that in the first embodiment on condition that the coupling portions 31 protrude rearward from the exterior component 21 (plate-shaped portion 22) and each have the shape of a plate.

The outer shape of the flat plate portion 34 may be changed to a shape different from that in the second embodiment, that is, a non-circular shape.

The flat plate portion 34 in the second embodiment may be omitted.

The flat plate portion 34 in the second embodiment may be divided into multiple pieces. The attachment portion 26 may be formed in a state of being integrated with and connected to each of the divided small pieces of the flat plate portion 34. The divided small pieces of the flat plate portion 34 may be formed in a state of being in close contact with the rear surface 22r of the plate-shaped portion 22 by a two-color molding process.

In the first embodiment, each connecting portion 32a may be formed to have substantially the same thickness as the other portions of the vertical coupling portion 32.

Also, each connecting portion 33a may be formed to have substantially the same thickness as the other portions of the lateral coupling portion 33.

### Modifications of Vibration Generator 40

The main body 41 may have a shape other than a columnar shape.

The shape of the support portion 44 may be changed to a shape different from those in the first and second embodiments. For example, at least one of the number, the size, and the shape of the arms 45 may be changed.

Further, the multiple arms 45 may be formed to be independent from each other, and each arm 45 may be separately fixed to the main body 41.

In the first and second embodiments, the vibration generator 40 is attached to the attachment portions 26 at positions forward of the front surface 41f of the main body 41 and outward in the radial direction of the outer circumferential surface 41c of the main body 41. Alternatively, the vibration generator 40 may be attached to the attachment portions 26 at positions forward of the front surface 41f of the main body 41, rearward of the rear surface of the main body 41, outward in the radial direction of the outer circumferential surface 41c.

The main body 41 and the support portion 44 may be formed integrally to form the vibration generator 40.

The vibration generator 40 may be attached to the attachment portions 26 by a method different from screw fastening. For example, attachment by clips, a snap-fit, welding, adhesion, or the like may be used.

### Modifications of Location of Vibration Generator 40

The vibration generator 40 may be any vibration generator that is disposed inside the exterior component 21 in the outward-inward direction of the vehicle 10, vibrates the exterior component 21 to generate sound waves, and emits the sound waves to the outside of the vehicle. In this case, the inward direction may be a direction different from the rearward direction (corresponding to the first and second embodiments) with respect to the exterior component 21, for example, a forward direction, an upward direction, a downward direction, a leftward direction, a rightward direction, or the like.

FIG. 7 shows an example in which the vibration generator 40 is disposed obliquely rearward and upward and of the exterior component 21.

Headlights 64 are disposed below a hood 63 of the vehicle 10 and on the opposite sides in the left-right direction. A lower portion that is a part of a front bumper 62 is disposed below the headlights 64. The front bumper 62 includes, at a part of its lower portion, an inclined plate portion 62a, which is inclined to be higher toward the front. In the front bumper 62, at least a portion including the inclined plate portion 62a may be formed by the exterior component 21. In the modification shown in FIG. 7, the vibration generator 40 is disposed obliquely rearward and upward of the inclined plate portion 62a. The interposed portions A are disposed between the inclined plate portion 62a and the vibration generator 40. The interposed portions A each include an attachment portion 26, to which the vibration generator 40 is attached, and a coupling portion 31 located between the exterior component 21 and the attachment portion 26. The interposed portions A are made of a plastic and formed integrally with the exterior component 21.

Behind the front bumper 62, a lower cover 61 is disposed to prevent the intrusion of debris, dust, water, and the like, during traveling of the vehicle 10, and to reduce the air resistance from the air passing beneath the vehicle 10.

In this modification, the thickness direction of the inclined plate portion 62a corresponds to the outward-inward direction of the vehicle 10. The “forward-downward direction” of each part of the sound output device 20 corresponds to the “outward direction” of the vehicle 10, and the “rearward-upward direction” of each part corresponds to the “inward direction” of the vehicle 10.

The configuration, other than the above, is the same as that of the first embodiment.

According to the modification shown in FIG. 7, the vibration of the vibration generator 40 is transmitted to the inclined plate portion 62a via the interposed portions A. The inclined plate portion 62a vibrates to emit sound waves obliquely forward and downward. Therefore, this modification is different from the first embodiment only in the location from which sound waves are emitted and the emitting direction of the sound waves. Therefore, this modification achieves the same advantages as those of the first embodiment. The same advantages include that the appearance of the exterior component 21 is improved by suppressing the formation of sink marks.

In the modification shown in FIG. 7, the sound output device 20 may have the same configuration as that of the second embodiment.

### Other Modifications

The exterior components 21, 51 may form a part or all of any of the components listed below, in addition to the front panel 11, the front grille, and the front bumper 62 described above.

Examples of the components include a rear bumper, a fog light cover, the hood 63, a cowl louver, a fender, a fender arch (wheel arch), a rocker panel, a roof molding, a pillar, the lower cover 61, a side trim, a rear trim, a spoiler, and the like.

What is claimed is:

1. A sound output device for a vehicle, comprising:
an exterior component forming a part of an outer shell of the vehicle;
a vibration generator disposed inward of the exterior component in an outward-inward direction of the vehicle; and
an interposed portion disposed between the exterior component and the vibration generator and having an attachment portion to which the vibration generator is attached, wherein
the sound output device is configured to transmit vibration of the vibration generator to the exterior component via the interposed portion to cause sound waves to be emitted from the exterior component, and
the interposed portion includes a plate-shaped joining portion between the exterior component and the attachment portion, the joining portion protruding inward in the outward-inward direction from the exterior component, and
the exterior component and the interposed portion are integrally formed of a plastic.

2. The sound output device for the vehicle according to claim 1, wherein the attachment portion is disposed only in a part of a gap between the exterior component and the vibration generator.

3. The sound output device for the vehicle according to claim 1, wherein
the vibration generator has a central axis extending in the outward-inward direction at a central portion of the vibration generator, and
the attachment portion is one of a plurality of attachment portions, the attachment portions being arranged around the central axis.

4. The sound output device for the vehicle according to claim 1, wherein the vibration generator is attached to the attachment portion by screwing a screw inserted through the vibration generator into the attachment portion.

5. The sound output device for the vehicle according to claim 1, wherein
the exterior component forms at least a part of one of a front panel having no opening and a front grille having an opening, and
the interposed portion is disposed rearward of the exterior component, and the vibration generator is disposed rearward of the interposed portion.

6. A sound output device for a vehicle, comprising:
an exterior component forming a part of an outer shell of the vehicle;
a vibration generator disposed inward of the exterior component in an outward-inward direction of the vehicle; and
an interposed portion disposed between the exterior component and the vibration generator and having an attachment portion to which the vibration generator is attached, wherein
the sound output device is configured to transmit vibration of the vibration generator to the exterior component via the interposed portion to cause sound waves to be emitted from the exterior component,
the exterior component is formed of a plastic,
the interposed portion is formed by a member different from the exterior component, and
the interposed portion is formed of a plastic in a state of being in close contact with an inner surface of the exterior component in the outward-inward direction.

7. The sound output device for the vehicle according to claim 6, wherein the attachment portion is disposed only in a part of a gap between the exterior component and the vibration generator.

8. The sound output device for the vehicle according to claim 6, wherein
the vibration generator has a central axis extending in the outward-inward direction at a central portion of the vibration generator, and
the attachment portion is one of a plurality of attachment portions, the attachment portions being arranged around the central axis.

9. The sound output device for the vehicle according to claim 6, wherein the vibration generator is attached to the attachment portion by screwing a screw inserted through the vibration generator into the attachment portion.

10. The sound output device for the vehicle according to claim 6, wherein
the exterior component forms at least a part of one of a front panel having no opening and a front grille having an opening, and
the interposed portion is disposed rearward of the exterior component, and the vibration generator is disposed rearward of the interposed portion.
